(19) United States
(12) Patent Application Publication
(10) Pub. No.: US 2025/0225053 A1
(43) Pub. Date: Jul. 10, 2025

(54) SYSTEM AND METHOD FOR OPTIMIZING FLOW ANALYSIS IN STATIC CODE ANALYSIS USING MACHINE LEARNING

(71) Applicant: PARASOFT CORPORATION, Monrovia, CA (US)

(72) Inventors: Leszek Jerzy Raszka, Czechowice Dziedzice (PL); Mariusz Woloszyn, Warsaw (PL)

(21) Appl. No.: 18/988,721

(22) Filed: Dec. 19, 2024

Related U.S. Application Data
(60) Provisional application No. 63/619,261, filed on Jan. 9, 2024.

(51) Int. Cl. G06F 11/3604

(52) U.S. Cl. CPC G06F 11/3604

(57) ABSTRACT

System and method for optimizing flow analysis for detections of code violations in a computer program, using machine learning include: analyzing the computer program for code violations; identifying functions or methods with execution path to code violations and creating a first dataset for suspicious functions or methods; identifying functions or methods with no execution path to code violations and creating a second dataset for unsuspicious functions or method; training a machine learning model to classify the suspicious and unsuspicious functions or method using the first and second datasets, wherein the trained model outputs a probability score for the methods or functions with execution paths to code violations; and utilizing the machine learning model to analyze code violations in a new computer program responsive to the probability scores for the methods or functions with execution paths to code violations.

### CROSS-REFERENCE TO RELATED APPLICATIONS

This Patent application claims the benefits of U.S. Provisional Patent Application Ser. No. 63/619,261, filed on Jan. 9, 2024, and entitled “System and Method for Optimizing Flow Analysis in Static Code Analysis Using Machine Learning,” the entire content of which is hereby expressly incorporated by reference.

### FIELD

The present disclosure relates generally to the field of software development and static code analysis. More specifically, the present disclosure pertains to a system and method for optimizing flow analysis in static code analysis using machine learning.

### BACKGROUND

Static code analysis is a critical process in software development, aimed at identifying potential code violations without executing the software. A key component of static code analysis is flow analysis, which examines potential execution paths within an program to identify areas where the code might not adhere to predefined standards or could introduce vulnerabilities. However, due to the vast number of execution paths that require examination, flow analysis can be time-consuming and may not cover all paths within the available analysis time. Therefore, there is a need for a system and method that can optimize the flow analysis process by prioritizing the examination of execution paths that are most likely to lead to violations.

### SUMMARY

In some embodiments, the present disclosure is directed to a method for optimizing flow analysis for detections of code violations in a computer program, using machine learning. The method includes: analyzing the computer program for code violations; identifying functions or methods with execution path to code violations and creating a first dataset for suspicious functions or methods; identifying functions or methods with no execution path to code violations and creating a second dataset for unsuspicious functions or method; training a machine learning model to classify the suspicious and unsuspicious functions or method using the first and second datasets, wherein the trained model outputs a probability score for the methods or functions with execution paths to code violations; and utilizing the machine learning model to analyze code violations in a new computer program responsive to the probability scores for the methods or functions with execution paths to code violations.

In some embodiments, the present disclosure is directed to a system for optimizing flow analysis for detections of code violations in a computer program, using machine learning. The system includes: a flow analysis engine for analyzing the computer program for code violations; means for identifying functions or methods with execution path to code violations and creating a first dataset for suspicious functions or methods; means for identifying functions or methods with no execution path to code violations and creating a second dataset for unsuspicious functions or method; means for training a machine learning model to classify the suspicious and unsuspicious functions or method using the first and second datasets, wherein the trained model outputs a probability score for the methods or functions with execution paths to code violations; and means for utilizing the machine learning model to analyze code violations in a new computer program responsive to the probability scores for the methods or functions with execution paths to code violations.

In some embodiments, the present disclosure is directed to a tangible storage medium for storing a plurality of computer codes, the plurality of computer codes when executed by one more computers performing a method for prioritizing code violations in a computer program, using machine learning. The method includes: analyzing the computer program for code violations; identifying functions or methods with execution path to code violations and creating a first dataset for suspicious functions or methods; identifying functions or methods with no execution path to code violations and creating a second dataset for unsuspicious functions or method; training a machine learning model to classify the suspicious and unsuspicious functions or method using the first and second datasets, wherein the trained model outputs a probability score for the methods or functions with execution paths to code violations; and utilizing the machine learning model to analyze code violations in a new computer program responsive to the probability scores for the methods or functions with execution paths to code violations.

### BRIEF DESCRIPTION OF THE DRAWINGS

A more complete appreciation of the disclosure, and many of the attendant features and aspects thereof, will become more readily apparent as the disclosure becomes better understood by reference to the following detailed description when considered in conjunction with the accompanying drawings in which like reference symbols indicate like components.

FIG. 1 shows an exemplary process for training a flow analysis optimization machine learning model, according to some embodiments of the disclosure.

FIG. 2 shows an exemplary process for creating flow analysis optimization machine learning model, according to some embodiments of the disclosure.

FIGS. 3A and 3B illustrate an exemplary process for using a flow analysis optimization machine learning model, according to some embodiments of the disclosure.

FIG. 4 depicts an exemplary general process for prioritizing examination of execution paths based on the probability associated with each function or method, according to some embodiments of the disclosure.

### DETAIL DESCRIPTION

The present disclosure provides a system and method for improving and optimizing flow analysis in static code analysis using machine learning. The approach trains a machine learning model, referred to as the “flow analysis optimization model,” to detect which starting methods lead to violations with high probability. In some embodiments, this model is trained using a dataset derived from scanning a large number of projects with a static analysis tool. The dataset indicates which functions or methods have an execution path originating from them that leads to a violation.

In some embodiments, the flow analysis optimization model assigns probability scores to methods or functions, and a flow analysis engine commences analysis with methods or functions that have the highest probability scores. This approach significantly enhances the efficiency of flow analysis, enabling the detection of a greater number of errors in a shorter time. The present disclosure thus provides a more efficient and effective method for conducting flow analysis in static code analysis, optimizing the use of analysis time, and enhancing the detection of code violations.

A flow analysis engine is a component of static analysis tools aimed at identifying violations in software applications without actual execution. Through the examination of source code, control flow graphs, or intermediate representations, the engine determines potential execution paths within an application. By tracing how data moves and interacts along these paths, it can pinpoint areas where the code might not adhere to predefined standards or could introduce vulnerabilities. Thus, by recognizing these potential violations, developers can rectify issues early in the development process, ensuring that the software conforms to desired quality and security benchmarks.

The primary challenge in static analysis during the evaluation of execution paths by a flow analysis engine is the sheer number of paths that require examination. This vast number of paths often leads to prolonged analysis durations. Consequently, due to limited analysis time, certain paths might not be examined at all. The flow analysis typically initiates its evaluation at methods that mark the beginning of the execution path. If a flow analysis optimization model can be trained to detect, with high probability, which starting methods lead to violations, the flow analysis for these specific execution paths can be readily prioritized. In this manner, the order of execution path analysis in the flow analysis engine is determined based on probability scores, that is, a range from 0.0 to 1.0.

This would significantly enhance the efficiency of flow analysis, possibly even enabling the detection of a greater number of errors. It would also pave the way for a rapid mode in flow analysis, aiming to detect the majority of violations in the shortest possible time. This rapid mode proves invaluable in a software development lifecycle environment, where a comprehensive analysis, typically time-consuming and perhaps conducted overnight, can be complemented by a quick scan capable of detecting most violations, offering timely insights to developers.

To create a flow analysis optimization model, the dataset is derived by scanning projects using a static analysis tool. By scanning a large number of projects with an appropriately configured static analysis program, one can obtain a dataset indicating which functions (or methods) have an execution path originating from that method (functions) that leads to a code violation. Information about these functions (or methods) serves as the foundation for training a machine learning model to identify similar methods. The source codes of these functions (and/or methods) are utilized during the model training process. The flow analysis optimization model assigns scores to methods (and/or functions) and orchestrate the flow analysis engine to commence analysis with methods (and/or functions) that have the highest probability scores.

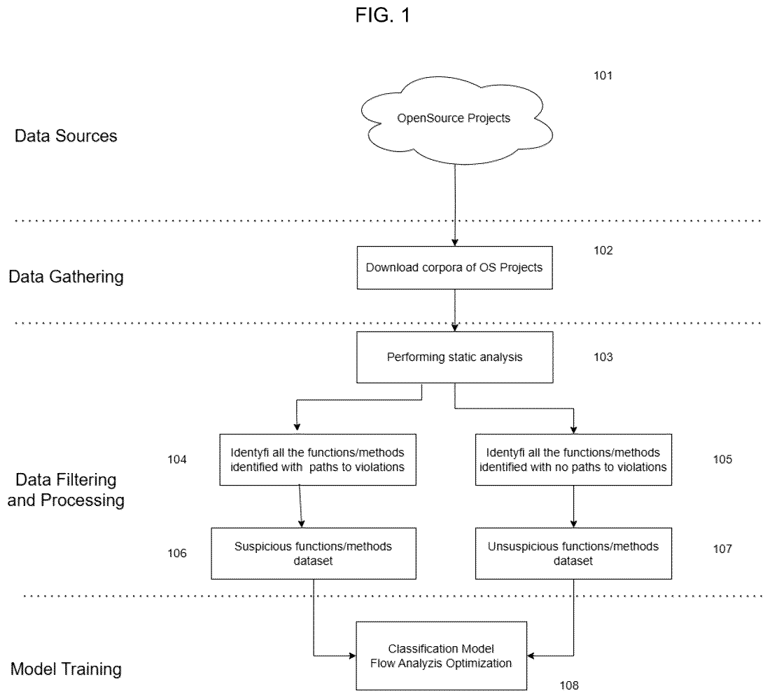

FIG. 1 shows an exemplary process for creating a flow analysis optimization machine learning model, according to some embodiments of the disclosure. In some embodiments, the process includes data collection, data filtering, and processing, followed by model training, as illustrated in FIG. 1. To effectively train the model, appropriate datasets are created, serving as the foundation for the training process. The primary data source for these datasets stems from a collection of open-source projects 101. As shown in block 102, individual open-source projects are fetched from repositories. In block 103, static analysis is performed on the local copies of open-source projects to evaluate the application under test. The static analysis tool houses the flow analysis engine that examines the pathways of the application under test. This tool identifies code violations in the application under test and report the program paths where these violations are detected.

The method or function at the beginning of a path, where static analysis initiates its examination, is referred to as an “entry point.” Once the static analysis tool, set with the right configurations, evaluates the application under test, it reports code violations, the program paths analyzed, and the entry points. In block 104, the functions and methods are identified (detected) with paths to violations in a dataset containing methods or functions (entry points) that initiate paths where the static analysis tool detected violations on its path. This dataset is referred to as the suspicious dataset 106 and contains code identified as a code violation or security risk, which needs to be fixed.

Similarly, in block 105 the functions and methods with paths to no violations are identified (detected). A dataset 107 with methods or functions (entry points) that initiate paths where no violations were identified by the static analysis tool on the path is then created. This dataset 107 is referred to as the unsuspicious dataset.

Using datasets 106 and 107, a classification model for flow analysis optimization is trained, in block 108. The model learns to estimate the probability for given method or function to serve as an entry point for violation.

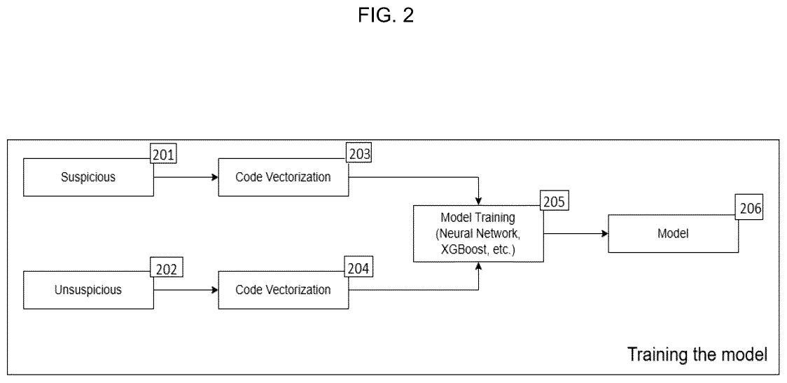

FIG. 2 shows an exemplary process for creating flow analysis optimization machine learning model, according to some embodiments of the disclosure. The process described here is a systematic approach to creating flow analysis optimization machine learning model. In some embodiments, the process includes creation of suspicious and unsuspicious datasets, vectorization of the code, model training, and the final model creation. The suspicious dataset 201 includes code snippets methods or functions, where the source codes of these functions (and/or methods) are utilized during the model training process. The unsuspicious dataset 202 includes code snippets methods or functions, where the source codes of these functions (and/or methods) are utilized during the model training process.

Once the suspicious dataset 201 is created, the code snippets are converted into a format that can be understood by a machine learning model. In some embodiments, this process is known as vectorization that involves transforming the text-based code snippets into numerical vectors, in block 203. Various known techniques can be used for this purpose, such as bag-of-words, TF-IDF, or word embeddings like Word2Vec or GloVe. The choice of vectorization technique depends on implementation detail.

Similarly, the code snippets in the unsuspicious dataset 202 are also vectorized, in block 204. The same vectorization technique used for the suspicious code snippets is used for the unsuspicious code snippets to ensure consistency. Once the code snippets for both the suspicious dataset 201 and unsuspicious dataset 202 have been vectorized, they are used to train a machine learning model 206, in block 205. Various types of models can be used for this purpose, including neural networks, XGBoost, or other types of classifiers. The choice of model depends on the specific implementation. During the training process, the model learns to differentiate between and classify the vectorized representations of the suspicious and unsuspicious code snippets. For instance, for neural network that performs logistic regression in its final layer, the network returns probability function (score)

$$P ( y = 1 \vert x ; w ) = \frac{1}{1 + {e}^{- {w}^{Tx}}} ,$$

where y is the true label of the sample (y∈[0,1], 0 means unsuspicious and 1 suspicious), x is the vector representation of the code snippet and w are the network weights of the logistic regression model.

This model 206 has been trained to differentiate between suspicious and unsuspicious code snippets and can be used to analyze new code snippets and predict their probability score for methods or functions (entry points) from which, when analyzed by static analysis, the originating execution paths reveal violations.

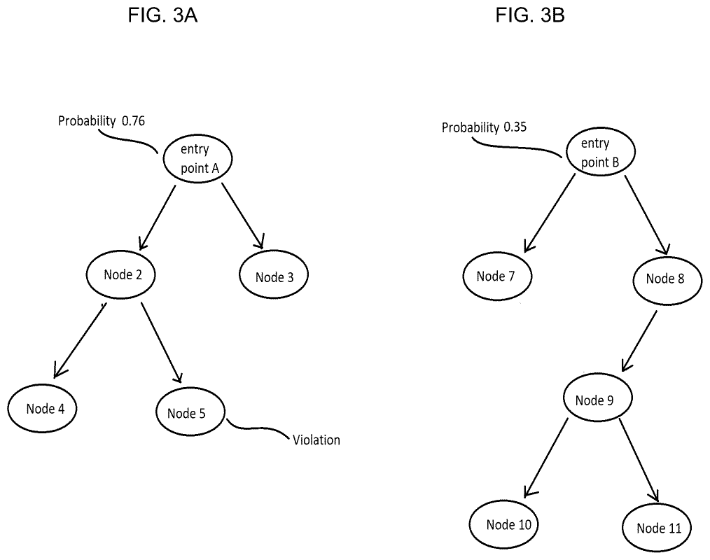

FIGS. 3A and 3B illustrate an exemplary process for using a flow analysis optimization machine learning model, according to some embodiments of the disclosure. Given the role of the flow analysis engines in tracing execution paths and identifying potential violations as previously described, two exemplary program trees are presented that are accompanied by the program's execution paths. A node in the depicted path represents either a method or function, depending on the programming language's structure. As shown in the example of FIG. 3A, the violation is located in Node 5. The machine learning model determines the probability of a violation's presence on each execution path that begin at a given entry point. Since, the probability for entry point A is 0.76, the flow analysis engine initiates its examination from this entry point.

As shown in the example of FIG. 3B, the execution paths starting at entry point B might be analyzed subsequently but given that their associated probability is 0.35, they may not be analyzed to optimize the process. Such an approach significantly boosts the efficiency of flow analysis because paths with the highest probability of leading to a violation are analyzed first.

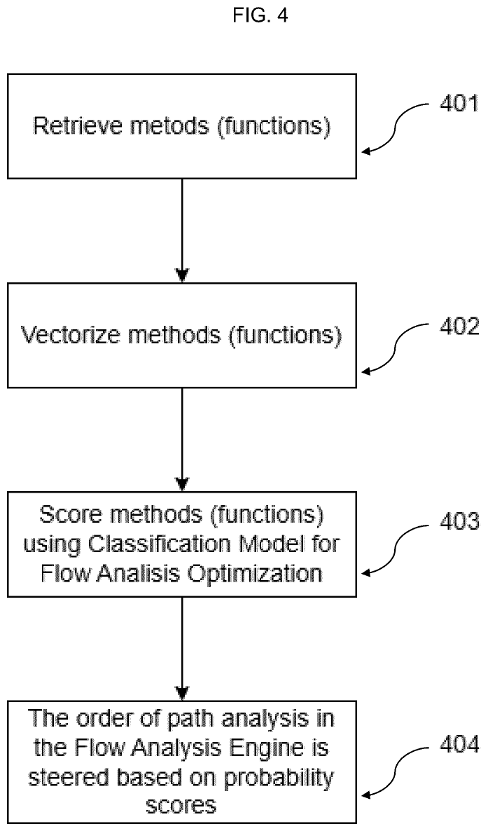

FIG. 4 depicts an exemplary general process flow where the flow analysis engine prioritizes examination of execution paths based on the probability associated with each function or method. As illustrated in block 401, each function (or method) is retrieved from the application under test. All functions (methods) are vectorized using the algorithms described in detail in the section on training the model, in block 402. In block 403, the obtained vectors are served as input to a classification model for flow analysis optimization, and classification results are estimated. Associated with each function (method) is a probability that an execution path originating from this function/method leads to a violation. The flow analysis engine then examines the paths that begin in methods with the highest probability first, and subsequently analyzes execution paths starting in methods with a lower probability, in block 404.

The flow analysis engine then monitors and traces how data moves and interacts along these execution paths and pinpoints areas where the code might not adhere to predefined standards or could introduce vulnerabilities. Thus, by recognizing these potential violations, developers can rectify issues early in the development process, ensuring that the software conforms to desired quality and security benchmarks.

In some embodiments, once the functions/methods are ranked based on their probability scores, the system executes the flow analysis engine to start examining execution paths from the higher-ranked, for example, 15% of the functions/methods. This approach aims to identify all or some of the code violations, achieving a higher detection rate in lower computation time. This significantly enhances the efficiency of flow analysis, possibly even enabling the detection of a greater number of errors. It also paves the way for a rapid mode in flow analysis, aiming to detect the majority of violations in the shortest possible time.

In some embodiments, the system finds 90% of errors in 30% of the time, or even allows for the detection of more errors than those found without prioritized entry points (functions/methods), as in normal mode the analysis ends after a set, limited analysis time. This prioritized approach to flow analysis allows for more efficient error detection by focusing on the most likely sources of issues, potentially uncovering more problems in less time compared to traditional methods. By training a flow analysis optimization model to assign scores to methods or functions based on their likelihood to lead to code violations, the approach allows for a more strategic, efficient and effective execution of flow analysis.

As known in the art, the above processes may be executed on a desktop computer or on one or more remote servers. Also, the processes may be stored on a tangible storage device to be accessed and executed by one or more computers.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope of the invention as defined by the appended claims and drawings.

1. A method for optimizing flow analysis for detections of code violations in a computer program, using machine learning, the method comprising:
analyzing the computer program for code violations;
identifying functions or methods with execution path to code violations and creating a first dataset for suspicious functions or methods;
identifying functions or methods with no execution path to code violations and creating a second dataset for unsuspicious functions or method;
training a machine learning model to classify the suspicious and unsuspicious functions or method using the first and second datasets, wherein the trained model outputs a probability score for the methods or functions with execution paths to code violations; and
utilizing the machine learning model to analyze code violations in a new computer program responsive to the probability scores for the methods or functions with execution paths to code violations.

2. The method of claim 1, wherein said utilizing the machine learning model to analyze code violations further comprises executing a flow analysis tool.

3. The method of claim 1, further comprising selecting a predetermined number of execution paths to code violations with highest probability scores for correcting the code violations.

4. The method of claim 1, further comprising ranking the functions or methods based on their probability scores.

5. The method of claim 1, wherein the code violations include security risks.

6. The method of claim 1, wherein said training the machine learning model comprises vectorizing the first and second datasets.

7. A system for optimizing flow analysis for detections of code violations in a computer program, using machine learning comprising:
a flow analysis engine for analyzing the computer program for code violations;
means for identifying functions or methods with execution path to code violations and creating a first dataset for suspicious functions or methods;
means for identifying functions or methods with no execution path to code violations and creating a second dataset for unsuspicious functions or method;
means for training a machine learning model to classify the suspicious and unsuspicious functions or method using the first and second datasets, wherein the trained model outputs a probability score for the methods or functions with execution paths to code violations; and
means for utilizing the machine learning model to analyze code violations in a new computer program responsive to the probability scores for the methods or functions with execution paths to code violations.

8. The system of claim 7, wherein said utilizing the machine learning model to analyze code violations further comprises executing a flow analysis tool.

9. The system of claim 7, further comprising selecting a predetermined number of execution paths to code violations with highest probability scores for correcting the code violations.

10. The system of claim 7, further comprising ranking the functions or methods based on their probability scores.

11. The system of claim 7, wherein the code violations include security risks.

12. The system of claim 7, wherein said training the machine learning model comprises vectorizing the first and second datasets.

13. A tangible storage medium for storing a plurality of computer codes, the plurality of computer codes when executed by one more computers performing a method for prioritizing code violations in a computer program, using machine learning, the method comprising:
analyzing the computer program for code violations;
identifying functions or methods with execution path to code violations and creating a first dataset for suspicious functions or methods;
identifying functions or methods with no execution path to code violations and creating a second dataset for unsuspicious functions or method;
training a machine learning model to classify the suspicious and unsuspicious functions or method using the first and second datasets, wherein the trained model outputs a probability score for the methods or functions with execution paths to code violations; and
utilizing the machine learning model to analyze code violations in a new computer program responsive to the probability scores for the methods or functions with execution paths to code violations.

14. The tangible storage medium of claim 13, wherein said utilizing the machine learning model to analyze code violations further comprises executing a flow analysis tool.

15. The tangible storage medium of claim 13, further comprising computer codes for selecting a predetermined number of execution paths to code violations with highest probability scores for correcting the code violations.

16. The tangible storage medium of claim 13, further comprising computer codes for ranking the functions or methods based on their probability scores.

17. The tangible storage medium of claim 13, wherein the code violations include security risks.

18. The tangible storage medium of claim 13, wherein said training the machine learning model comprises vectorizing the first and second datasets.
